(19) United States
(12) Patent Application Publication
(10) Pub. No.: US 2023/0194275 A1
(43) Pub. Date: Jun. 22, 2023

(54) SYSTEMS AND METHODS FOR COMMUNICATING UNCERTAINTY AROUND STATIONARY OBJECTS

(71) Applicant: HERE GLOBAL B.V., Eindhoven (NL)

(72) Inventors: DMITRY KOVAL, BERLIN (DE); JEROME BEAUREPAIRE, BERLIN (DE)

(21) Appl. No.: 17/557,021

(22) Filed: Dec. 20, 2021

(51) Int. Cl. G01C 21/34; B60W 60/00; B60W 30/10

(52) U.S. Cl. CPC G01C 21/3461; B60W 60/00272; B60W 30/10; B60W 2554/4049

(57) ABSTRACT

Systems and methods for communicating uncertainty around stationary objects are provided. For example, a method for communicating uncertainty around stationary objects includes receiving sensor data corresponding to a stationary object at a location along a road segment. The sensor data is captured via one or more sensors of a first vehicle. The method also includes based on the sensor data, determining a level of uncertainty corresponding to the stationary object. The method also includes based on the determined level of uncertainty, providing an instruction for one or more sensors of a second vehicle to capture additional sensor data corresponding to the stationary object at the location along the road segment.

### TECHNICAL FIELD

The present disclosure relates generally to object detection, and more specifically to systems and methods for communicating uncertainty around stationary objects.

### BACKGROUND

The term autonomous vehicle refers to a vehicle including automated mechanisms for performing one or more human operated aspects of vehicle control. As autonomous vehicles are adopted, several benefits may be realized. Vehicle collisions may be reduced because computers can perform driving tasks more consistently and make fewer errors than human operators. Traffic congestion may be alleviated because autonomous vehicles observe specified gaps between vehicles, preventing stop and go traffic. However, uncertainty around stationary objects on or near the road are still likely to constitute hazards. Since autonomous vehicles are likely to encounter unknown stationary objects there is a need to communicate uncertainty related to the detection of unknown stationary objects.

### BRIEF SUMMARY

The present disclosure overcomes the shortcomings of prior technologies. In particular, a novel approach for communicating uncertainty around stationary objects is provided, as detailed below.

In accordance with an aspect of the disclosure, a method for communicating uncertainty around stationary objects is provided. The method includes receiving sensor data corresponding to a stationary object at a location along a road segment. The sensor data is captured via one or more sensors of a first vehicle. The method also includes based on the sensor data, determining a level of uncertainty corresponding to the stationary object. The method also includes based on the determined level of uncertainty, providing an instruction for one or more sensors of a second vehicle to capture additional sensor data corresponding to the stationary object at the location along the road segment.

In accordance with another aspect of the present disclosure, a non-transitory computer-readable storage medium is provided. The non-transitory computer-readable storage medium includes one or more sequences of one or more instructions for execution by one or more processors of a device. The one or more instructions which, when executed by the one or more processors, cause the device to receive sensor data corresponding to a stationary object at a location along a road segment. The one or more instructions further cause the device to, based on the sensor data, determine a level of uncertainty corresponding to the stationary object. The one or more instructions further cause the device to encode the level of uncertainty in a database to facilitate one or more aspects of vehicle operation for one or more vehicles travelling along the road segment. Also, a computer program product may be provided. For example, a computer program product comprising instructions which, when the program is executed by a computer, cause the computer to carry out the steps described herein.

In accordance with another aspect of the disclosure, an apparatus is provided. The apparatus includes a processor. The apparatus also includes a memory comprising computer program code for one or more programs. The computer program code is configured to cause the processor of the apparatus to receive uncertainty data associated with a stationary object at a location along a road segment. The computer program code is further configured to cause the processor of the apparatus to generate a data point for a map layer associated with the road segment based on the uncertainty data. The data point indicates a level of uncertainty associated with the stationary object at the location along the road segment. The computer program code is further configured to cause the processor of the apparatus to store the data point in a database associated with the map layer. The map layer comprises the data point and one or more other data points that indicate one or more other locations corresponding to respective levels of uncertainty for one or more other stationary objects along one or more road segments.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of communicating uncertainty around stationary objects, in accordance with aspects of the present disclosure;

FIG. 2A is a diagram of an example scenario for communicating uncertainty around stationary objects, in accordance with aspects of the present disclosure;

FIG. 2B is a diagram of another example scenario for communicating uncertainty around stationary objects, in accordance with aspects of the present disclosure;

FIG. 2C is a diagram of another example scenario for communicating uncertainty around stationary objects, in accordance with aspects of the present disclosure;

FIG. 3 is a diagram of an example map layer, in accordance with aspects of the present disclosure;

FIG. 4 is a diagram of a geographic database, in accordance with aspects of the present disclosure;

FIG. 5 is a diagram of the components of a data analysis system, in accordance with aspects of the present disclosure;

FIG. 6 is a flowchart setting forth steps of an example process, in accordance with aspects of the present disclosure;

FIG. 7 is a flowchart setting forth steps of another example process, in accordance with aspects of the present disclosure;

FIG. 8 is a flowchart setting forth steps of another example process, in accordance with aspects of the present disclosure;

FIG. 9 is a diagram of an example computer system, in accordance with aspects of the present disclosure;

FIG. 10 is a diagram of an example chip set, in accordance with aspects of the present disclosure; and

FIG. 11 is a diagram of an example mobile device, in accordance with aspects of the present disclosure.

### DESCRIPTION OF SOME EMBODIMENTS

Examples of a method, a non-transitory computer-readable storage medium, and an apparatus for communicating uncertainty around stationary objects are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

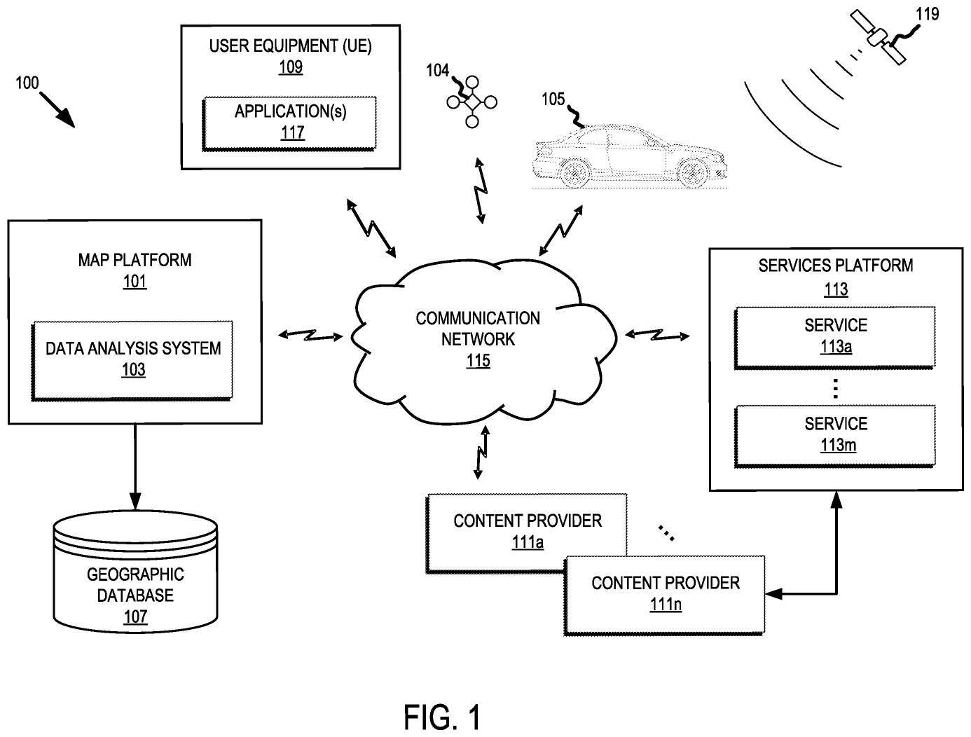

FIG. 1 is a diagram of a system 100 capable of communicating uncertainty around stationary objects, according to one embodiment. In one embodiment, the system 100 of FIG. 1 is configured to receive sensor data corresponding to a stationary object at a location along a road segment. The sensor data is captured via one or more sensors of a first vehicle. In this embodiment, the system 100 is configured to, based on the sensor data, determine a level of uncertainty corresponding to the stationary object. Continuing with this embodiment, the system 100 is configured to, based on the determined level of uncertainty, provide an instruction for one or more sensors of a second vehicle to capture additional sensor data corresponding to the stationary object at the location along the road segment.

In another embodiment, the system 100 of FIG. 1 is configured to receive sensor data corresponding to a stationary object at a location along a road segment. In this embodiment, the system 100 is configured to, based on the sensor data, determine a level of uncertainty corresponding to the stationary object. Continuing with this embodiment, the system 100 is configured to encode the level of uncertainty in a database to facilitate one or more aspects of vehicle operation for one or more vehicles travelling along the road segment.

In one embodiment, the system 100 of FIG. 1 is configured to receive uncertainty data associated with a stationary object at a location along a road segment. In this embodiment, the system 100 is configured to generate a data point for a map layer associated with the road segment based on the uncertainty data. The data point indicates a level of uncertainty associated with the stationary object at the location along the road segment. Continuing with this embodiment, the system 100 is configured to store the data point in a database associated with the map layer. The map layer comprises the data point and one or more other data points that indicate one or more other locations corresponding to respective levels of uncertainty for one or more other stationary objects along one or more road segments.

Referring to FIG. 1, the map platform 101 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating information for communicating uncertainty around stationary objects or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, information for communicating uncertainty around stationary objects, location-based services, news services, etc. In one embodiment, the services platform 113 may interact with the map platform 101, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, mapping content, textual content, audio content, video content, image content, etc. In one embodiment, the one or more content providers 111a-111n may provide content that may aid in communicating uncertainty around stationary objects according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

In one embodiment, the drone 104 is equipped with logic, hardware, firmware, software, memory, etc. to collect, store, and/or transmit data measurements from their respective sensors continuously, periodically, according to a schedule, on demand, etc. In one embodiment, the logic, hardware, firmware, memory, etc. can be configured to perform all or a portion of the various functions associated with communicating uncertainty around stationary objects according to the various embodiments described herein. The drone 104 can also include means for transmitting the collected and stored data over, for instance, the communication network 115 to the map platform 101 and/or any other components of the system 100 for communicating uncertainty around stationary objects and/or initiating navigational services or other map-based functions.

In one embodiment, the drone 104 is an unmanned aerial vehicle (UAV). The UAV may be configured to operate in one or more modes (e.g., an autonomous mode or a semi-autonomous mode). In one example, the UAV may be configured to sense its environment or operate in the air without a need for input from an operator, among others. In another example, the UAV may be controlled by a remote human operator, while some functions are carried out autonomously. Further, the UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another, while the UAV's navigation system autonomously controls more fine-grained navigation decisions, such as the specific route to take between the two locations, specific flight controls to achieve the route and avoid obstacles while navigating the route, and so on. It is envisioned that other examples are also possible. By way of example, a drone can be of various forms. For example, a drone may take the form of a rotorcraft such as a helicopter or multicopter, a fixed-wing aircraft, a jet aircraft, a ducted fan aircraft, a lighter-than-air dirigible such as a blimp or steerable balloon, a tail-sitter aircraft, a glider aircraft, and/or an ornithopter, among other possibilities.

In one embodiment, drones can be associated other vehicles (e.g., connected and/or autonomous cars). These other vehicles equipped with various sensors can act as probes traveling over a road network within a geographical area represented in the geographic database 107. Accordingly, the data sensed from locations along the road network can be associated with different areas (e.g., map tiles, geographical boundaries, etc.) and/or other features (e.g., road links, nodes (intersections), POIs) represented in the geographic database 107. Although the vehicles are often described herein as automobiles, it is contemplated that the vehicles can be any type of vehicle, manned or unmanned (e.g., planes, aerial drone, boats, etc.). In one embodiment, the drone 104 is assigned a unique identifier for use in reporting or transmitting data and/or related probe data (e.g., location data).

In one embodiment, the vehicle 105 may be a standard gasoline powered vehicle, a hybrid vehicle, an electric vehicle, a fuel cell vehicle, and/or any other mobility implement type of vehicle. The vehicle 105 includes parts related to mobility, such as a powertrain with an engine, a transmission, a suspension, a driveshaft, and/or wheels, etc. In another example, the vehicle 105 may be an autonomous vehicle. The autonomous vehicle may be a manually controlled vehicle, semi-autonomous vehicle (e.g., some routine motive functions, such as parking, are controlled by the vehicle), or an autonomous vehicle (e.g., motive functions are controlled by the vehicle without direct driver input).

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, user equipment (e.g., a mobile phone, a portable electronic device, etc.) may be integrated in the vehicle, which may include assisted driving vehicles such as autonomous vehicles, highly assisted driving (HAD), and advanced driving assistance systems (ADAS). Any of these assisted driving systems may be incorporated into the user equipment. Alternatively, an assisted driving device may be included in the vehicle.

The term autonomous vehicle may refer to a self-driving or driverless mode in which no passengers are required to be on board to operate the vehicle. An autonomous vehicle may be referred as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate and respond to lane marking indicators (lane marking type, lane marking intensity, lane marking color, lane marking offset, lane marking width, or other characteristics) and driving commands or navigation commands.

In one embodiment, the vehicle 105 may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In one embodiment, the user equipment (UE) 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for communicating uncertainty around stationary objects. In another non-limiting example, application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103 and perform one or more functions associated with communicating uncertainty around stationary objects, either alone or in combination with the data analysis system 103.

In some embodiments, the UE 109, the drone 104, and/or the vehicle 105 may include various sensors for acquiring a variety of different data or information. For instance, the UE 109, the drone 104, and/or the vehicle 105 may include one or more camera/imaging devices for capturing imagery (e.g., terrestrial images), global positioning system (GPS) sensors or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109, the drone 104, and/or the vehicle 105 may also include one or more light sensors, height sensors, accelerometers (e.g., for determining acceleration and vehicle orientation), magnetometers, gyroscopes, inertial measurement units (IMUs), tilt sensors (e.g., for detecting the degree of incline or decline), moisture sensors, pressure sensors, and so forth. Further, the UE 109, the drone 104, and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109, the drone 104, and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109, the drone 104, and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6, and layer 7) headers as defined by the OSI Reference Model.

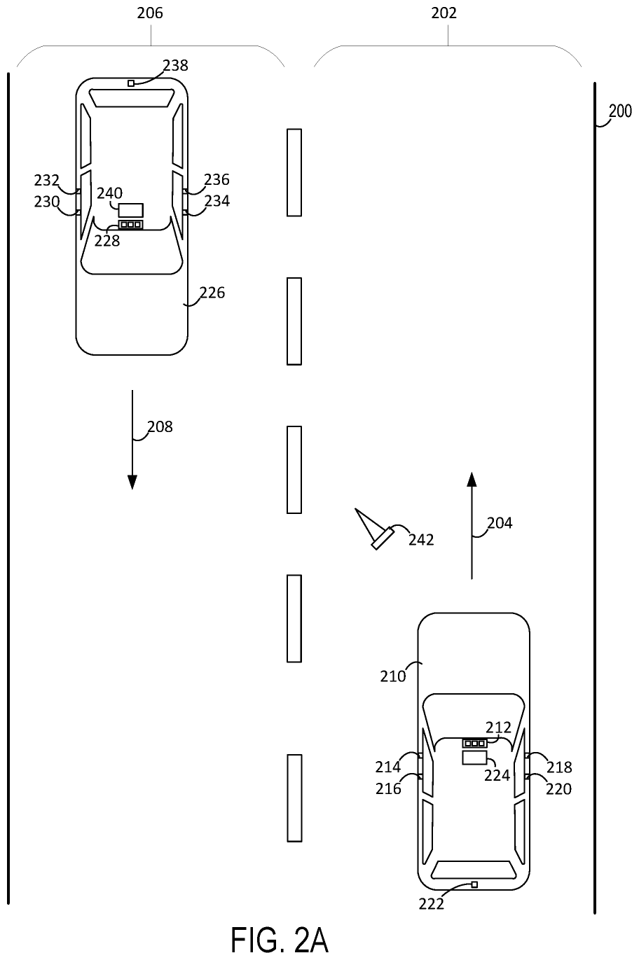

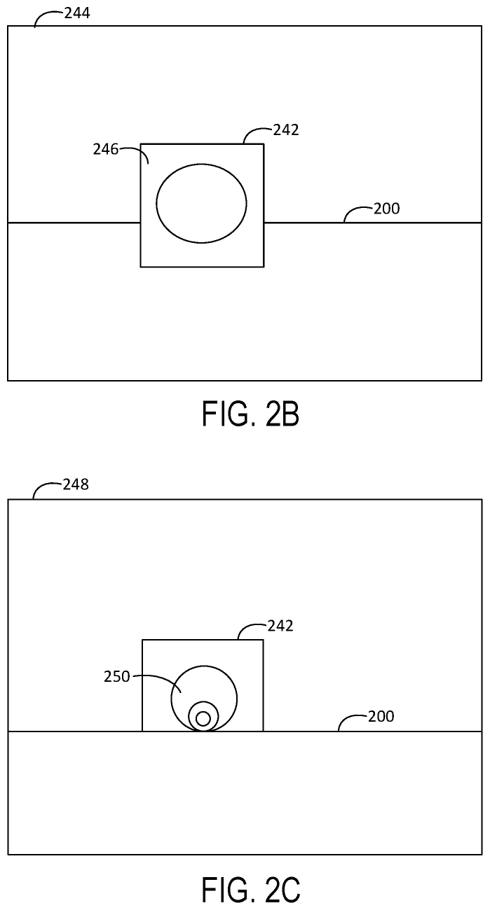

FIG. 2A is a diagram illustrating an example scenario for communicating uncertainty around a stationary object. As shown, a road segment 200 includes a first lane 202 associated with a direction of travel 204. The road segment 200 also includes a second lane 206 associated with a direction of travel 208. As shown in FIG. 2A, a first vehicle 210 is depicted as travelling in the first lane 202 along the direction of travel 204. The first vehicle 210 includes sensors 212, 214, 216, 218, 220, and 222. The first vehicle 210 also includes an apparatus 224. As shown in FIG. 2A, a second vehicle 226 is depicted as travelling in the second lane 206 along the direction of travel 208. The second vehicle 226 includes sensors 228, 230, 232, 234, 236, and 238. The second vehicle also includes an apparatus 240. As shown in FIG. 2A, a traffic cone 242 is depicted as fallen over within the first lane 202.

In one example, the system 100 of FIG. 1 is configured to receive sensor data corresponding to a stationary object (i.e., the traffic cone 242) at a location along the road segment 200. The sensor data is captured via one or more sensors of the sensors 212, 214, 216, 218, 220 and 222 of the first vehicle 210 while the first vehicle 210 travels on the road segment 200 along the direction of travel 204. In this example, the system 100 is also configured to determine a level of uncertainty corresponding to the stationary object. Based on the position of the traffic cone 242 relative to the approach of the first vehicle 210, the sensor data corresponding to the traffic cone 242 may make it difficult to determine that the stationary object is a traffic cone. Continuing with this example, the system 100 is configured to, based on the determined level of uncertainty, provide an instruction for one or more sensors of the sensors 228, 230, 232, 234, 236, and 238 of the second vehicle 226 to capture additional sensor data corresponding to the stationary object at the location along the road segment 200.

In one example, the level of uncertainty may be assigned a numerical value within a predetermined range. For example, a numerical value of 100 may correspond to the highest level of uncertainty and a numerical value of 0 may correspond to the lowest level of uncertainty. In one scenario, the highest level of uncertainty (e.g., 100) is associated with sensor data of an object that does not enable the system 100 of FIG. 1 to classify the stationary object as a known object. In another scenario, the lowest level of uncertainty (e.g., 0) is associated with sensor data of an object that enables the system 100 to classify the stationary object as a known object.

In one example, the sensor data captured via the one or more sensors of the sensors 212-222 of the first vehicle 210 may include image data as shown in FIG. 2B. FIG. 2B is a diagram illustrating an image 244. As shown in FIG. 2B, the bottom 246 of the traffic cone 242 is visible based on the approach of the first vehicle 210 of FIG. 2A traveling in the first lane 202. In this example, the system 100 of FIG. 1 may determine that the level of uncertainty corresponding to the stationary object (i.e., the traffic cone 242) is 50. In other words, the system 100 may determine that it is likely a traffic cone but also likely that is it another object (e.g., a subwoofer). Due to the system 100 being unable to determine what the stationary object is, the system 100 may use additional sensor data to assist in classifying the stationary object.

Referring back to FIG. 2A, in one example, the system 100 of FIG. 1 is configured to receive the additional sensor data, captured from the one or more sensors of the sensors 228-238 of the second vehicle 226, corresponding to the stationary object (i.e., the traffic cone 242) at the location along the road segment 200. In this example, the system 100 is configured to, based on the senor data from the one or more sensors of the sensors 212-222 of the first vehicle 210 and the additional sensor data from the one or more sensors of the sensors 228-238 of the second vehicle 226, modify the determined level of uncertainty corresponding to the stationary object at the location along the road segment 200.

In one example, the sensor data captured via the one or more sensors of the sensors 228-238 of the second vehicle 226 may include image data as shown in FIG. 2C. FIG. 2C is a diagram illustrating an image 248. As shown in FIG. 2C, the conical top 250 of the traffic cone 242 is visible based on the approach of the second vehicle 226 of FIG. 2A traveling in the second lane 206. In this example, the system 100 of FIG. 1 may be configured to modify the level of uncertainty corresponding to the stationary object (i.e., the traffic cone 242) to 0 based on the analysis of the sensor data from the one or more sensors of the sensors 212-222 of the first vehicle 210 of FIG. 2A and the additional sensor data from the one or more sensors of the sensors 228-238 of the second vehicle 226. In other words, the system 100 may be configured to resolve the uncertainty around the stationary object and classify the stationary object as a traffic cone. In one example, based on the classification of the stationary object, the system 100 may be configured to provide one or more notifications to one or more vehicles travelling along the first lane 202 of the road segment 200. In one example, the notification may be provided as a warning that the traffic cone 242 is present and therefore to proceed with caution as approaching that location along the road segment 200.

Referring back to FIG. 2A, in one example, the system 100 of FIG. 1 is configured to receive sensor data corresponding to a stationary object (i.e., the traffic cone 242) at a location along the road segment 200. In this example, the system 100 is also configured to determine a level of uncertainty corresponding to the stationary object. Continuing with this example, the system 100 is configured to encode the level of uncertainty in a database (e.g., the geographic database 107 of FIG. 1) to facilitate one or more aspects of vehicle operation for one or more vehicles travelling along the road segment 200.

In one example, the encoded level of uncertainty may be utilized by the system 100 of FIG. 1 to modify one or more aspects of vehicle operation such as an adjustment in a level of autonomous operation for an autonomous vehicle. For example, an autonomous vehicle may receive in instruction to decrease from a Level 2 autonomous level that corresponds to partial automation for the vehicle to a Level 1 autonomous level that corresponds to a certain degree of driver assistance for the vehicle as the autonomous vehicle approaches the stationary object along the road segment 200. In another example, the encoded level of uncertainty may be utilized by the system 100 to modify one or more aspects of vehicle operation such as the speed that an autonomous vehicle is traveling as the autonomous vehicle approaches the stationary object along the road segment 200. In one example, the level of uncertainty may be utilized by the system 100 to modify one or more aspects of vehicle operation such as an adjustment to a route that includes the road segment 200.

In one example, the system 100 of FIG. 1 is configured to receive uncertainty data associated with a stationary object (i.e., the traffic cone 242) at a location along a road segment 200. In this example, the system 100 is configured to generate a data point for a map layer associated with the road segment 200 based on the uncertainty data. The data point indicates a level of uncertainty associated with the stationary object at the location along the road segment 200. Continuing with this example, the system 100 is configured to store the data point in a database (e.g., the geographic database 107 of FIG. 1) associated with the map layer. The map layer comprises the data point and one or more other data points that indicate one or more other locations corresponding to respective levels of uncertainty for one or more other stationary objects along one or more road segments.

In one example, the apparatus 224 may include a processor and a memory comprising computer program code for one or more programs. The computer program code is configured to cause the processor of the apparatus 224 to receive sensor data corresponding to a stationary object (i.e., the traffic cone 242) at a location along the road segment 200. The sensor data is captured via one or more sensors of the sensors 212, 214, 216, 218, 220 and 222 of the first vehicle 210 while the first vehicle 210 travels on the road segment 200 along the direction of travel 204. In this example, the apparatus 224 is also configured to determine a level of uncertainty corresponding to the stationary object. Continuing with this example, the apparatus 224 is configured to, based on the determined level of uncertainty, provide an instruction for one or more sensors of the sensors 228, 230, 232, 234, 236, and 238 of the second vehicle 226 to capture additional sensor data corresponding to the stationary object at the location along the road segment 200.

In another example, the apparatus 224 may include a processor and a memory comprising computer program code for one or more programs. The computer program code is configured to cause the processor of the apparatus 224 to receive sensor data, via one or more sensors of the sensors 212, 214, 216, 218, 220 and 222, corresponding to a stationary object (i.e., the traffic cone 242) at a location along the road segment 200 while the vehicle 210 is travelling along the road segment 200. In this embodiment, the apparatus 204 may be configured to, based on the sensor data, determine a level of the uncertainty corresponding to the stationary object. Continuing with this embodiment, the apparatus 204 may be configured to encode the level of uncertainty in a database (e.g., the geographic database 107 of FIG. 1) to facilitate one or more aspects of vehicle operation for one or more vehicles traveling along the road segment 200.

In one example, the apparatus 224 may include a processor and a memory comprising computer program code for one or more programs. The computer program code is configured to cause the processor of the apparatus 224 to receive uncertainty data associated with a stationary object (i.e., the traffic cone 242) at a location along the road segment 200. In this example, the apparatus 224 is also configured to generate a data point for a map layer associated with the road segment 200 based on the uncertainty data. The data point indicates a level of uncertainty associated with the stationary object at the location along the road segment 200. Continuing with this example, the apparatus 224 is configured store the data point in a database (e.g., the geographic database 107 of FIG. 1) associated with the map layer. The map layer comprises the data point and one or more other data points that indicate one or more other locations corresponding to respective levels of uncertainty for one or more other stationary objects along one or more road segments.

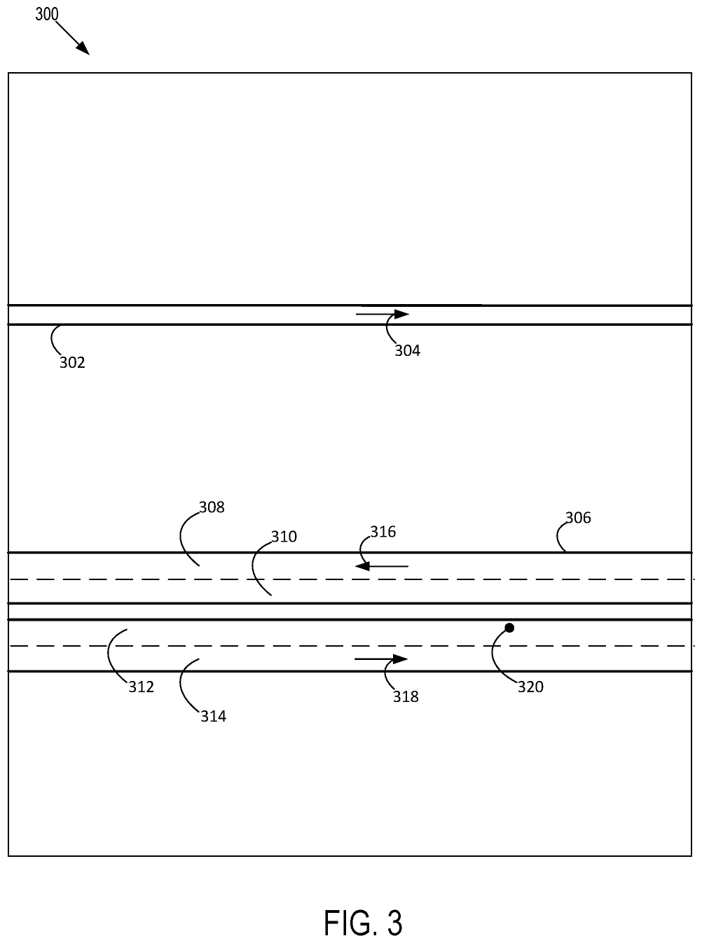

FIG. 3 is a diagram illustrating a map layer 300. The map layer 300 includes a road segment 302 associated with a direction of travel 304. The map layer 300 also includes a road segment 306. The road segment 306 includes a first lane 308, a second lane 310, a third lane 312, and a fourth lane 314. The first lane 308 and the second lane 310 are associated with a direction of travel 316. The third lane 312 and the fourth lane 314 are associated with a direction of travel 318. As shown, the map layer 300 also include a data point 320 associated with the road segment 306.

In one example, the data point 320 is stored in a database (e.g., the geographic database 107 of FIG. 1) associated with the map layer 300. In one example, the data point 320 includes information that indicates a level of uncertainty associated with a stationary object along the road segment 306. In one example, the data point 320 is based on sensor data corresponding to the stationary object that was captured via one or more sensors of at least one vehicle travelling along the road segment 306.

In one example, the system 100 of FIG. 1 is configured to receive additional sensor data corresponding to the stationary object and based on the additional sensor data, update the stored data point 320 in the database. In one example, the system 100 is configured to modify the level of uncertainty associated with the stationary object. In one scenario, the system 100 is configured to increase the level of uncertainty based on the additional sensor data leading to inconclusive results. In one example, the additional sensor data may include image data that is provided to a convolutional neural network (CNN) for performing image classification. In one example, if the CNN is unable to classify the stationary object within the image data, then the system 100 may be configured to increase the level of uncertainty associated with the stationary object. In another example, if the CNN can classify the stationary object within the image data, then the system 100 may be configured to decrease the level of uncertainty associated with the stationary object. In one example, the system 100 may be configured to remove the stored data point 320 from the database based on a decrease in the level of uncertainty.

In one example, the system 100 of FIG. 1 may be configured to analyze one or more aspects of an area based on the location data corresponding to the stored data point 320. In this example, the system 100 may be configured to determine a path for a vehicle to travel along while capturing additional sensor data corresponding to the stationary object. In one example, if a vehicle is traveling the road segment 306 in the first lane 308, then the system 100 may be configured to provide an instruction to the vehicle to switch to the second lane 310 while the vehicle approaches the stationary object. In another example, if a vehicle is traveling along the road segment in the third lane 312, then the system 100 may be configured to provide an instruction to switch to the fourth lane 314 so that the vehicle avoids a collision with the stationary object. In one example, the system 100 may be configured to determine a route that avoids the stationary object. For example, based on the level of uncertainty associated with the data point 320, the system 100 may be configured to provide an instruction for a vehicle to utilize the road segment 302 instead of travelling along the road segment 306.

In one example, the system 100 of FIG. 1 may be configured to determine a level of priority corresponding to the stored data point 320. In this example, the system 100 may be configured to update the stored data point based on the determined level of priority. In one example, the road segment 306 may be a road segment that is associated with high levels of vehicular traffic during certain times of the day. Continuing with this example, the system 100 may be configured to prioritize providing an instruction to one or more vehicles to capture additional sensor data of the stationary object associated with the data point 320 depending on the time of the day and a duration of time associated with a level of uncertainty. In one example, the system 100 may utilize the duration of time associated with the level of uncertainty as a parameter for routing one or more vehicles away from the location of the stationary object. In another example, the system may utilize the duration of time associated with the level of uncertainty as a parameter for routing one or more vehicle towards the location of the stationary object.

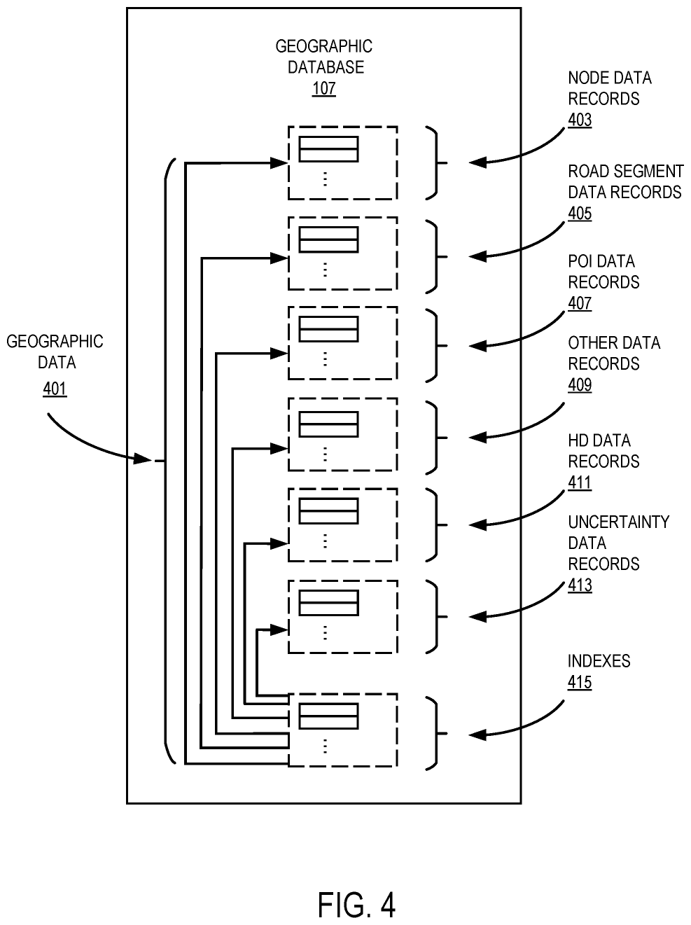

FIG. 4 is a diagram of the geographic database 107 of the system 100 of FIG. 1, according to exemplary embodiments. In the exemplary embodiments, the information generated by the map platform 101 can be stored, associated with, and/or linked to the geographic database 107 or data thereof. In one embodiment, the geographic database 107 includes geographic data 401 used for (or configured to be compiled to be used for) mapping and/or navigation-related services, such as for personalized route determination, according to exemplary embodiments. For example, the geographic database 107 includes node data records 403, road segment data records 405, POI data records 407, other data records 409, HD data records 411, uncertainty data records 413, and indexes 415, for example. It is envisioned that more, fewer or different data records can be provided.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 405 are links or segments representing roads, streets, or paths, as can be used in the calculated route or recorded route information for determination of one or more personalized routes, according to exemplary embodiments. The node data records 403 are end points or vertices (such as intersections) corresponding to the respective links or segments of the road segment data records 405. The road segment data records 405 and the node data records 403 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 407. In one example, the POI data records 407 may include the hours of operation for various businesses. The geographic database 107 can also include data about places, such as cities, towns, or other communities, and other geographic features, such as bodies of water, mountain ranges, etc. Such place or feature data can be part of the POI data records 407 or can be associated with POIs or POI data records 407 (such as a data point used for displaying or representing a position of a city).

In one embodiment, other data records 409 include cartographic (“carto”) data records, routing data, weather data, and maneuver data. In one example, the other data records 409 include data that is associated with certain POIs, roads, or geographic areas. In one example, the data is stored for utilization by a third-party. In one embodiment, the other data records 409 include weather data records such as weather data reports. For example, the weather data records can be associated with any of the map features stored in the geographic database 107 (e.g., a specific road or link, node, intersection, area, POI, etc.) on which the weather data was collected. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one embodiment, the geographic database 107 may also include point data records for storing the point data, map features, as well as other related data used according to the various embodiments described herein. In addition, the point data records can also store ground truth training and evaluation data, machine learning models, annotated observations, and/or any other data. By way of example, the point data records can be associated with one or more of the node data records 403, road segment data records 405, and/or POI data records 407 to support verification, localization or visual odometry based on the features stored therein and the corresponding estimated quality of the features. In this way, the point data records can also be associated with or used to classify the characteristics or metadata of the corresponding records 403, 405, and/or 407.

As discussed above, the HD data records 411 may include models of road surfaces and other map features to centimeter-level or better accuracy. The HD data records 411 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 411 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD data records 411 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 411.

In one embodiment, the HD data records 411 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the uncertainty data records 413 include sensor data, location data, level of uncertainty data, and vehicle data. In one example, the sensor data may include the types of sensors (e.g., image sensors, LIDAR sensors, RADAR sensors, etc.) used to capture the sensor data associated with an unknown stationary object. In one example, the location data may be determined according to one or more GPS sensors. In one example, the level of uncertainty data associated with one or more stationary objects may be provided by one or more components of a system (e.g., the system 100 of FIG. 1) or an apparatus (e.g., the apparatus 224 of FIG. 2A) of a vehicle. In one example, the vehicle data may include one or more aspects (e.g., direction of travel, speed of the vehicle, route travelled, lane utilization, etc.) associated with the vehicle as the vehicle approaches an unknown stationary object. In one example, the uncertainty data records 413 include data that is associated with certain POIs, roads, or geographic areas. In one example, the uncertainty data records 413 are stored for utilization by a third-party. In one embodiment, the uncertainty data records 413 include weather data records such as weather data reports. For example, the weather data records can be associated with any of the map features stored in the geographic database 107 (e.g., a specific road or link, node, intersection, area, POI, etc.) on which the weather data was collected. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

The indexes 415 in FIG. 4 may be used improve the speed of data retrieval operations in the geographic database 107. Specifically, the indexes 415 may be used to quickly locate data without having to search every row in the geographic database 107 every time it is accessed. For example, in one embodiment, the indexes 415 can be a spatial index of the polygon points associated with stored feature polygons.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

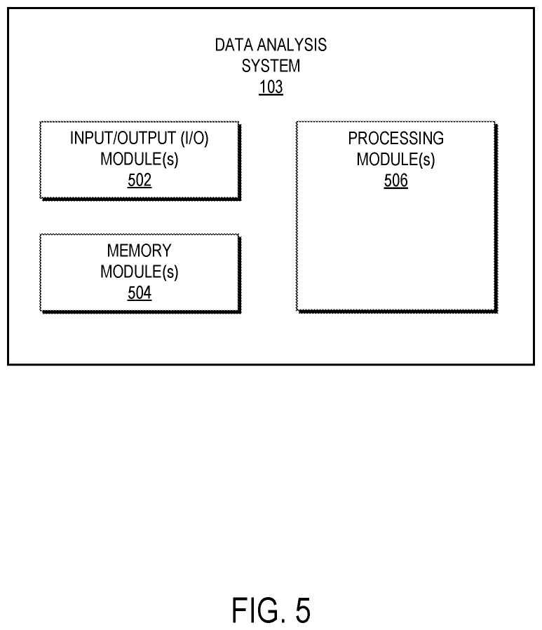

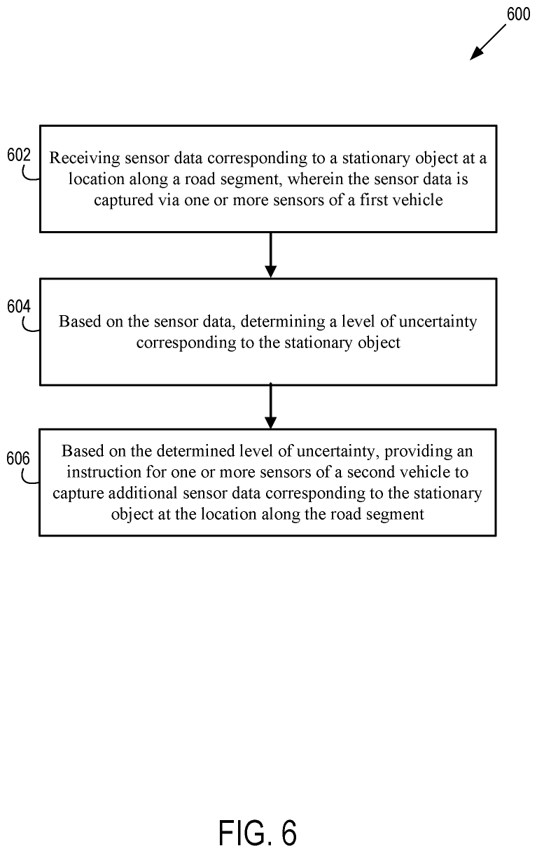

FIG. 5 is a diagram of the components of the data analysis system 103 of FIG. 1, according to one embodiment. By way of example, the data analysis system 103 includes one or more components for communicating uncertainty around stationary objects according to the various embodiments described herein. It is contemplated that the functions of these components may be combined or performed by other components of equivalent functionality. In this embodiment, data analysis system 103 includes an input/output module 502, a memory module 504, and a processing module 506. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 502-506 may be implemented as a cloud-based service, local service, native application, or combination thereof. The functions of these modules are discussed with respect to FIGS. 6, 7, and 8 below.

FIGS. 6, 7, and 8 are flowcharts of example methods, each in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowcharts of FIGS. 6, 7, and 8 each show the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIGS. 6, 7, and 8 may represent circuitry that is wired to perform the specific logical functions in the process. Illustrative methods, such as those shown in FIGS. 6, 7, and 8, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIGS. 6, 7, and 8 may be fully performed by a computing device (or components of a computing device such as one or more processors) or may be distributed across multiple components of the computing device, across multiple computing devices, and/or across a server.

Referring first to FIG. 6, an example method 600 may include one or more operations, functions, or actions as illustrated by blocks 602-606. The blocks 602-606 may be repeated periodically or performed intermittently, or as prompted by a user, device, or system. In one embodiment, the method 600 is implemented in whole or in part by the data analysis system 103 of FIG. 5.

As shown by block 602, the method 600 includes receiving sensor data corresponding to a stationary object at a location along a road segment, wherein the sensor data is captured via one or more sensors of a first vehicle. In one example, the input/output module 502 of FIG. 5 is configured to receive sensor data corresponding to a stationary object at a location along a road segment. In one example, the sensor data is captured via one or more sensors of a first vehicle. Continuing with this example, the processing module 506 of FIG. 5 is configured to receive the sensor data from the input/output module 502.

As shown by block 604, the method 600 also includes based on the sensor data, determining a level of uncertainty corresponding to the stationary object. In one example, the processing module 506 of FIG. 5 is configured to, based on the sensor data, determine a level of uncertainty corresponding to the stationary object. In one example, the processing module 506 of FIG. 5 is configured to determine the level of uncertainty by performing an analysis of the sensor data corresponding to the stationary object at the location along the road segment. In one example, the sensor data includes image data, and the analysis is based on image localization and image classification of the image data.

In one example, a vehicle (e.g., the vehicle 105 of FIG. 1) may be equipped with an apparatus (e.g., the apparatus 224 of FIG. 2A) for determining the level of uncertainty corresponding to the stationary object. In this example, based on the determined level of uncertainty, the apparatus may be configured to communicate the level of uncertainty corresponding to the stationary object to a system (e.g., the system 100 of FIG. 1). In one example, the system may be configured to determine the reasons and conditions related to the level of uncertainty corresponding to the stationary object. In one scenario, the system may be configured to determine that the level of uncertainty is based on the weather conditions associated with the location of the stationary object. In another scenario, the system may be configured to determine that the level of uncertainty corresponding to the stationary object is based on one or more sensors of the vehicle failing to operate properly.

As shown by block 606, the method 600 also includes based on the determined level of uncertainty, providing an instruction for one or more sensors of a second vehicle to capture additional sensor data corresponding to the stationary object at the location along the road segment. In one example, the processing module 506 of FIG. 5 is configured to provide an instruction, via the input/output module 502 of FIG. 5, for one or more sensors of a second vehicle to capture additional sensor data corresponding to the stationary object at the location along the road segment. In one example, the determined level of uncertainty may be utilized to provide an instruction for controlling one or more sensors of the second vehicle based on the second vehicle's approach to the location of the stationary object. In another example, the determined level of uncertainty may be utilized to select a second vehicle that is equipped with specific sensors for capturing the additional sensor data.

In another example, the processing module 506 of FIG. 5 is configured to provide one or more instructions, via the input/output module 502 of FIG. 5, for one or more sensors of a drone (e.g., the drone 104 of FIG. 1) to capture additional sensor data corresponding to the stationary object at the location along the road segment. In one example, the one or more instructions include an instruction for performing a navigation function of the drone for approaching the location along the road segment. In another example, the one or more instructions include an instruction for modifying one or more aspects (e.g., speed, heading, altitude, etc.) of the operation of the drone. In one example, the one or more instructions may include an instruction for activating one or more sensors (e.g., image sensors, etc.) for capturing the additional sensor data corresponding to the stationary object at the location along the road segment.

In one embodiment, the method 600 may further include analyzing one or more aspects of an area that includes the location along the road segment. In this embodiment, the method 600 may further include based on the analysis, determining a path for the second vehicle to travel along during the capture of the additional sensor data. In one example, the processing module 506 of FIG. 5 is configured to analyze one or more aspects of an area that includes the location along the road segment. In this example, the processing module 506 is further configured to, based on the analysis, determine a path for the second vehicle to travel along during the capture of the additional sensor data.

In another embodiment, the method 600 may further include determining a first lane of travel associated with the sensor data obtained via the one or more sensors of the first vehicle. In this embodiment, the method 600 may further include determining a second lane of travel for the second vehicle to travel along during the capture of the additional sensor data. In one example the processing module 506 is configured to determine a first lane of travel associated with the sensor data obtained via the one or more sensors of the first vehicle. In this example, the processing module 506 is further configured to determine a second lane of travel for the second vehicle to travel along during the capture of the additional sensor data.

In one embodiment, the method 600 may further include generating a data point for a map layer associated with the location along the road segment based on the sensor, wherein the data point indicates a level of uncertainty associated with the stationary object. In this embodiment, the method 600 may further include storing the data point in a database associated with the map layer, wherein the map layer comprises the data point and one or more other data points that indicate one or more other locations corresponding to respective levels of uncertainty for one or more other stationary objects along one or more road segments. In one example, the processing module 506 of FIG. 5 is configured to generate a data point for a map layer associated with the location along the road segment based on the sensor data. The data point indicates a level of uncertainty associated with the stationary object. In this example, the processing module 506 is further configured to store the data point in a database (e.g., the geographic database 107 of FIG. 1) associated with the map layer. The map layer comprises the data point and one or more other data points that indicate one or more other locations corresponding to respective levels of uncertainty for one or more other stationary objects along one or more road segments.

In one embodiment, the method 600 also includes mapping the generated data point onto one or more map data layers of a high-definition map to provide one or more instructions for operation of a vehicle. In one embodiment, the method 600 also includes linking the generated data point with one or more portions, components, areas, layers, features, text, symbols, and/or data records of a map (e.g., an HD map). In one example, the processing module 506 of FIG. 5 is configured to map the generated data point onto one or more map data layers of a high-definition map to provide the one or more instructions for operation of a vehicle. In this example, the processing module 506 is further configured to link the generated data point with one or more portions, components, areas, layers, features, text, symbols, and/or data records of a map (e.g., an HD map).

In one embodiment, the method 600 may further include determining a route from a current location to a destination via a plurality of road segments, wherein the plurality of road segments to be part of the route is determined according to the level of uncertainty corresponding to the stationary object at the location along the road segment. In one example, the processing module 506 of FIG. 5 is configured to determine a route from a current location to a destination via a plurality of road segments. In this example, the plurality of road segments to be part of the route is determined according to the level of uncertainty corresponding to the stationary object at the location along the road segment.

In another embodiment, the method 600 may further include determining a level of priority corresponding to the stored data point. In this embodiment, the method 600 may further include based on the determined level of priority, updating the stored data point. In one example, the processing module 506 of FIG. 5 is configured to determine a level of priority corresponding to the stored data point. In this example, the processing module 506 is further configured to, based on the determined level of priority, update the stored data point.

In one embodiment, the method 600 may further include receiving the additional sensor data corresponding to the stationary object at the location along the road segment. In this embodiment, the method 600 may further include based on the sensor data and the additional sensor data, modifying the determined level of uncertainty corresponding to the stationary object. In one example, the processing module 506 of FIG. 5 is configured to receive the additional sensor data, via the input/output module 502 of FIG. 5, corresponding to the stationary object at the location along the road segment. In this example, the processing module 506 is further configured to, based on the sensor data and the additional sensor data, modify the determined level of uncertainty corresponding to the stationary object.

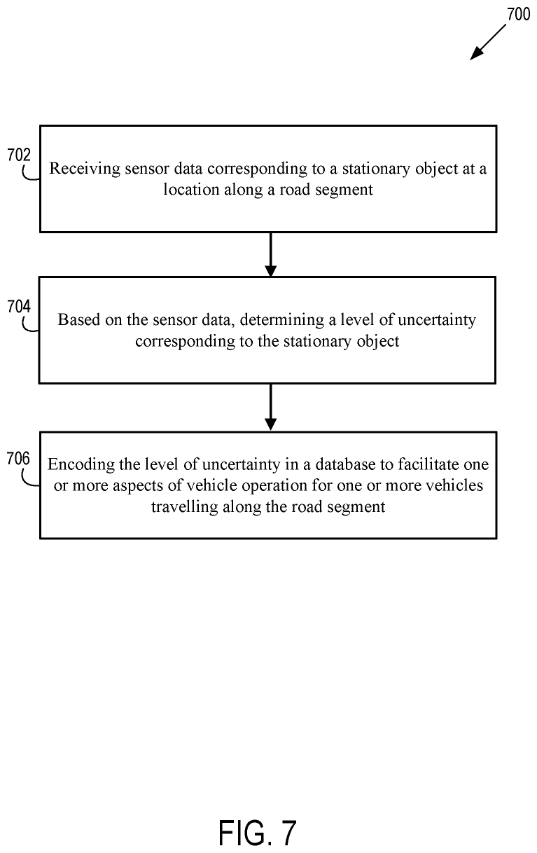

Referring to FIG. 7, the example method 700 may include one or more operations, functions, or actions as illustrated by blocks 702-706. The blocks 702-706 may be repeated periodically or performed intermittently, or as prompted by a user, device, or system. In one embodiment, the method 700 is implemented in whole or in part by the data analysis system 103 of FIG. 5.

As shown by block 702, the method 700 includes receiving sensor data corresponding to a stationary object at a location along a road segment. Block 702 may be similar in functionality to block 602 of method 600.

As shown by block 704, the method 700 also includes based on the sensor data, determining a level of uncertainty corresponding to the stationary object. Block 704 may be similar in functionality to block 604 of method 600.

As shown by block 706, the method 700 also includes encoding the level of uncertainty in a database to facilitate one or more aspects of vehicle operation for one or more vehicles travelling along the road segment. In one example, the processing module 506 of FIG. 5 is configured to encode the level of uncertainty in a database to facilitate one or more aspects of vehicle operation for one or more vehicles travelling along the road segment. In one example, utilization of the encoded level of uncertainty in the database may include an instruction for notifying one or more drivers to proceed with caution as they approach the location along the road segment corresponding to the stationary object.

In one embodiment, the method 700 may further include determining one or more modifications to the one or more aspects of the vehicle operation for the one or more vehicles traveling along the road segment. In one example, the processing module 506 of FIG. 5 is configured to determine one or more modifications to the one or more aspects of the vehicle operation for the one or more vehicles traveling along the road segment. In one embodiment, the one or more modifications to the one or more aspects of the vehicle operation for the one or more vehicles comprises an adjustment in a level of autonomous operation for an autonomous vehicle. In another embodiment, the one or more modifications to the one or more aspects of the vehicle operation for the one or more vehicles comprises at least one adjustment to a route utilized by the one or more vehicles, wherein the route includes the road segment.

In one embodiment, the method 700 may further include determining a level of priority corresponding to the encoded level of uncertainty. In one example, the processing module 506 of FIG. 5 is configured to determine a level of priority corresponding to the encoded level of uncertainty. In one embodiment, the method 700 may further include receiving the additional sensor data corresponding to the stationary object at the location along the road segment. In this embodiment, the method 700 may further include based on the sensor data and the additional sensor data, modifying the encoded level of uncertainty corresponding to the stationary object at the location along the road segment. In one example, the level of priority may be assigned numerical values (e.g., high priority=3, medium priority=2, low priority level=1). In one example, the levels of priority correspond to the amount of vehicle traffic associated with a road segment. In another example, the levels of priority correspond to the availability of alternative routes that do not include the road segment.

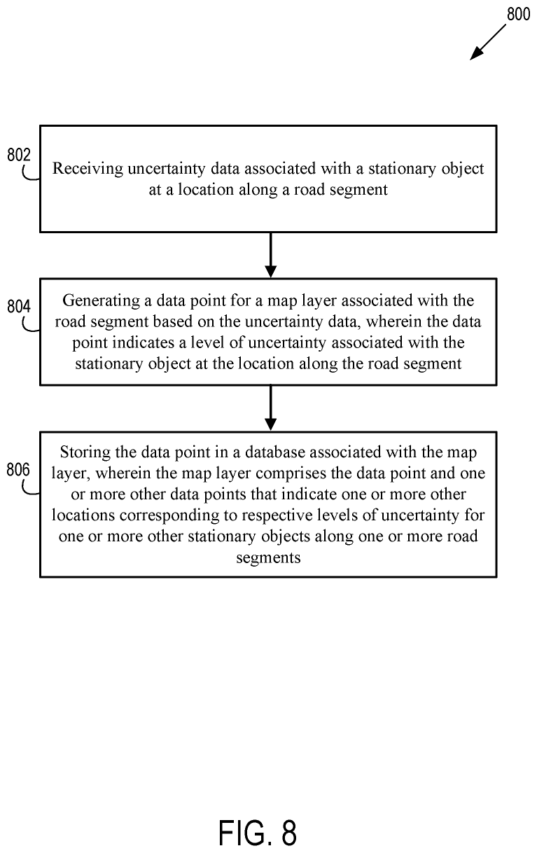

Referring to FIG. 8, the example method 800 may include one or more operations, functions, or actions as illustrated by blocks 802-806. The blocks 802-806 may be repeated periodically or performed intermittently, or as prompted by a user, device, or system. In one embodiment, the method 800 is implemented in whole or in part by the data analysis system 103 of FIG. 5.

As shown by block 802, the method 800 includes receiving uncertainty data associated with a stationary object at a location along a road segment. In one embodiment, the uncertainty data is based on sensor data corresponding to the stationary object captured via one or more sensors of at least one vehicle traveling along the road segment. In one example, the processing module 506 of FIG. 5 is configured to receive uncertainty data associated with a stationary object at a location along a road segment.

As shown by block 804, the method 800 also includes generating a data point for a map layer associated with the road segment based on the uncertainty data, wherein the data point indicates a level of uncertainty associated with the stationary object at the location along the road segment. In one example, the processing module 506 of FIG. 5 is configured to generate a data point for a map layer associated with the road segment based on the uncertainty data. In this example, the data point indicates a level of uncertainty associated with the stationary object at the location along the road segment.

As shown by block 806, the method 800 also includes storing the data point in a database associated with the map layer, wherein the map layer comprises the data point and one or more other data points that indicate one or more other locations corresponding to respective levels of uncertainty for one or more other stationary objects along one or more road segments. In one example, the processing module 506 of FIG. 5 is configured to store the data point in a database associated with the map layer. In this example, the map layer comprises the data point and one or more other data points that indicate one or more other locations corresponding to respective levels of uncertainty for one or more other stationary objects along one or more road segments.

In one embodiment, the method 800 may further include receiving additional sensor data corresponding to the stationary object. In this embodiment, the method 800 may further include based on the additional sensor data, updating the stored data point in the database. In one example, the processing module 506 of FIG. 5 is configured to receive additional sensor data corresponding to the stationary object. In this example, the processing module 506 is further configured to, based on the additional sensor data, update the stored data point in the database. In one example, the additional sensor data corresponding to the stationary object may be received from a portable device (e.g., the UE 109 of FIG. 1) associated with an individual nearby the location of the stationary object. In another example, the additional sensor data corresponding to the stationary object may be received from image data captured via a satellite.

In one embodiment, the method 800 may further include modifying the level of uncertainty associated with the stationary object. In one embodiment, the method 800 may further include removing the stored data point in the database based on a decrease in the level of uncertainty. In one example, the processing module 506 of FIG. 5 is configured to modify the level of uncertainty associated with the stationary object. In this example, the processing module 506 is configured to remove the stored data point in the database based on a decrease in the level of uncertainty.

In one embodiment, the method 800 may further include determining a level of priority corresponding to the stored data point. In this embodiment, the method 800 may further include based on the determined level of priority, updating the stored data point. In one example, the processing module 506 of FIG. 5 is configured to determine a level of priority corresponding to the stored data point. In this example, the processing module 506 of is configured to, based on the determined level of priority, update the stored data point.

The processes described herein for communicating uncertainty around stationary objects may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

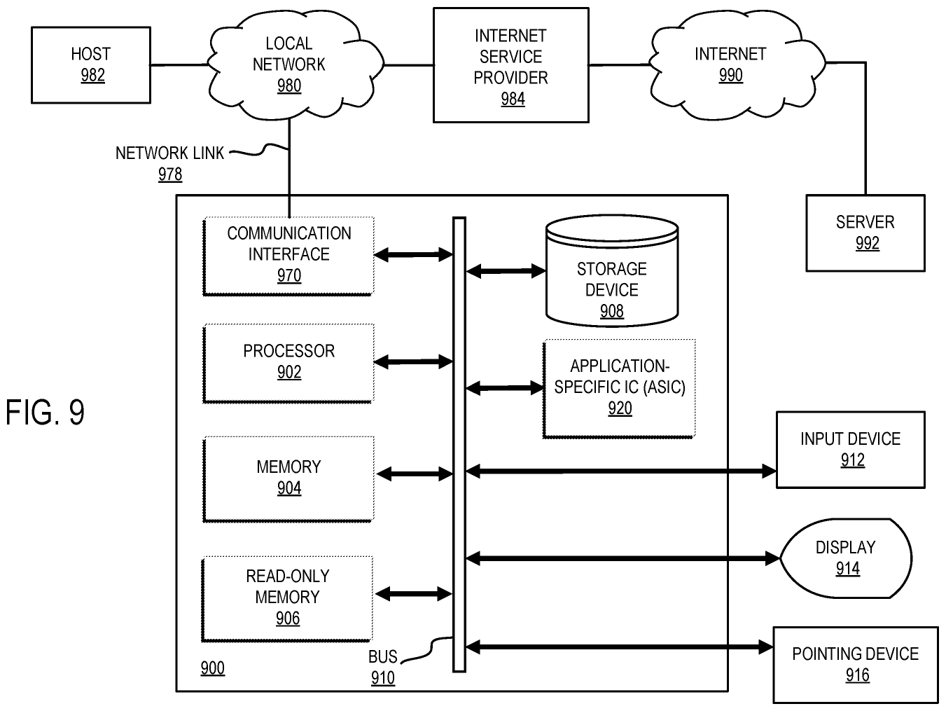

FIG. 9 illustrates a computer system 900 upon which an embodiment may be implemented. Computer system 900 is programmed (e.g., via computer program code or instructions) to provide information for communicating uncertainty around stationary objects as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to communicating uncertainty around stationary objects. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random-access memory (RAM) or other dynamic storage device, stores information including processor instructions for communicating uncertainty around stationary objects. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for communicating uncertainty around stationary objects, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in the computer system 900. Other external devices coupled to bus 910, used primarily for interacting with humans, include a display 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 900 may also include one or more instances of a communications interface 970 coupled to bus 910. The communication interface 970 may provide a one-way or two-way communication coupling to a variety of external devices that operate with their own processors, such as printers, scanners and external disks. In addition, the communication interface 970 may provide a coupling to a local network 980, by way of a network link 978. The local network 980 may provide access to a variety of external devices and systems, each having their own processors and other hardware. For example, the local network 980 may provide access to a host 982, or an internet service provider 984, or both, as shown in FIG. 9. The internet service provider 984 may then provide access to the Internet 990, in communication with various other servers 992.

The computer system 900 also includes one or more instances of a communication interface 970 coupled to bus 910. Communication interface 970 provides a one-way or two-way communication coupling to a variety of external devices that operate with their own processors, such as printers, scanners and external disks. In general, the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, the communication interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, the communication interface 970 may be a local area network (LAN) card to provide a data communication connection to a compatible LAN, such as Ethernet. Wireless links may also be implemented. For wireless links, the communication interface 970 sends or receives or both sends and receives electrical, acoustic or electromagnetic signals, including infrared and optical signals, that carry information streams, such as digital data. For example, in wireless handheld devices, such as mobile telephones like cell phones, the communication interface 970 includes a radio band electromagnetic transmitter and receiver called a radio transceiver. In certain embodiments, the communication interface 970 enables connection to the communication network 115 of FIG. 1 for providing information for communicating uncertainty around stationary objects.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

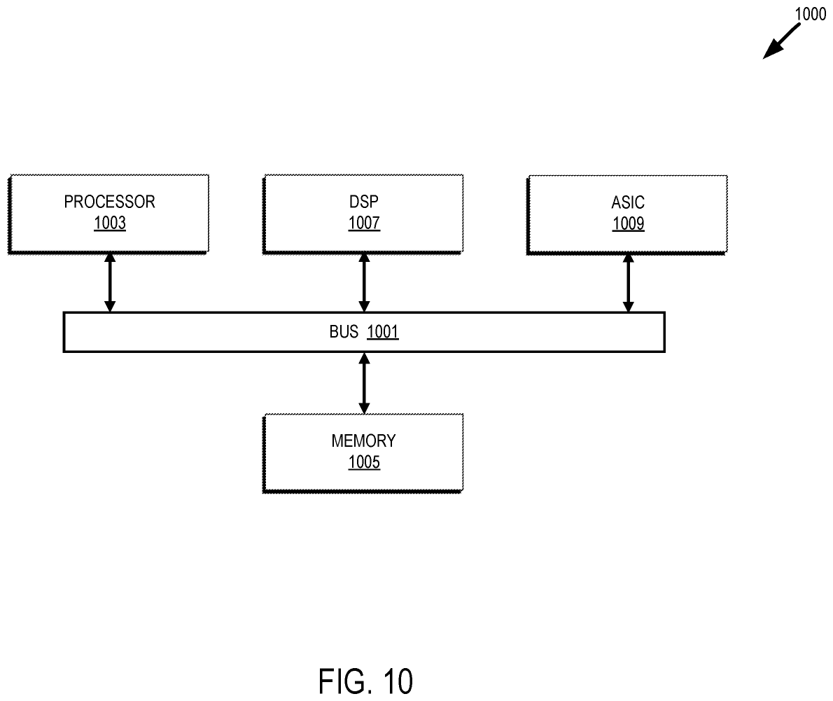

FIG. 10 illustrates a chip set 1000 upon which an embodiment may be implemented. The chip set 1000 is programmed to communicate uncertainty around stationary objects as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the steps described herein to provide information for communicating uncertainty around stationary objects. The memory 1005 also stores the data associated with or generated by the execution of the inventive steps.

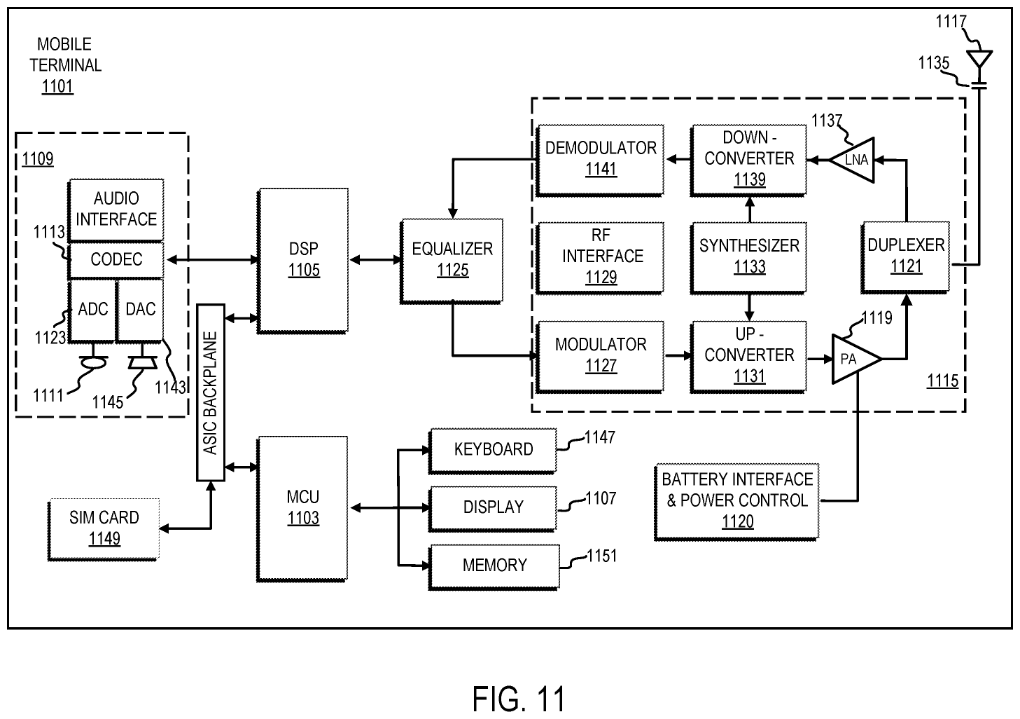

FIG. 11 is a diagram of exemplary components of a mobile terminal 1101 (e.g., a mobile device, vehicle, drone, and/or part thereof) capable of operating in the system 100 of FIG. 1, according to one embodiment. Generally, a radio receiver is often defined in terms of front-end and back-end characteristics. The front-end of the receiver encompasses all of the Radio Frequency (RF) circuitry whereas the back end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to provide information for communicating uncertainty around stationary objects. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

We (I) claim:

1. A method of communicating uncertainty around stationary objects, the method comprising:
receiving sensor data corresponding to a stationary object at a location along a road segment, wherein the sensor data is captured via one or more sensors of a first vehicle;
based on the sensor data, determining a level of uncertainty corresponding to the stationary object; and
based on the determined level of uncertainty, providing an instruction for one or more sensors of a second vehicle to capture additional sensor data corresponding to the stationary object at the location along the road segment.

2. The method of claim 1, further comprising:
receiving the additional sensor data corresponding to the stationary object at the location along the road segment; and
based on the sensor data and the additional sensor data, modifying the determined level of uncertainty corresponding to the stationary object.

3. The method of claim 1, further comprising:
generating a data point for a map layer associated with the location along the road segment based on the sensor data, wherein the data point indicates a level of uncertainty associated with the stationary object; and
storing the data point in a database associated with the map layer, wherein the map layer comprises the data point and one or more other data points that indicate one or more other locations corresponding to respective levels of uncertainty for one or more other stationary objects along one or more road segments.

4. The method of claim 3, further comprising:
determining a route from a current location to a destination via a plurality of road segments, wherein the plurality of road segments to be part of the route is determined according to the level of uncertainty corresponding to the stationary object at the location along the road segment.

5. The method of claim 3, further comprising:
determining a level of priority corresponding to the stored data point; and
based on the determined level of priority, updating the stored data point.

6. The method of claim 1, wherein providing the instruction for the one or more sensors of the second vehicle to capture the additional sensor data corresponding to the stationary object at the location along the road segment further comprises:
analyzing one or more aspects of an area that includes the location along the road segment; and
based on the analysis, determining a path for the second vehicle to travel along during the capture of the additional sensor data.

7. The method of claim 6, wherein determining the path for the second vehicle to travel along during the capture of the additional sensor data further comprises:
determining a first lane of travel associated with the sensor data obtained via the one or more sensors of the first vehicle; and
determining a second lane of travel for the second vehicle to travel along during the capture of the additional sensor data.

8. A non-transitory computer-readable storage medium comprising one or more instructions for execution by one or more processors of a device, the one or more instructions which, when executed by the one or more processors, cause the device to:
receive sensor data corresponding to a stationary object at a location along a road segment;
based on the sensor data, determine a level of uncertainty corresponding to the stationary object; and
encode the level of uncertainty in a database to facilitate one or more aspects of vehicle operation for one or more vehicles travelling along the road segment.

9. The non-transitory computer-readable storage medium of claim 8, wherein the one or more instructions which, when executed by the one or more processors, further cause the device to:
determine one or more modifications to the one or more aspects of the vehicle operation for the one or more vehicles traveling along the road segment.

10. The non-transitory computer-readable storage medium of claim 9, wherein the one or more modifications to the one or more aspects of the vehicle operation for the one or more vehicles comprises an adjustment in a level of autonomous operation for an autonomous vehicle.

11. The non-transitory computer-readable storage medium of claim 9, wherein the one or more modifications to the one or more aspects of the vehicle operation for the one or more vehicles comprises at least one adjustment to a route utilized by the one or more vehicles, wherein the route includes the road segment.

12. The non-transitory computer-readable storage medium of claim 8, wherein the one or more instructions which, when executed by the one or more processors, further cause the device to provide an instruction to capture additional sensor data corresponding to the stationary object at the location along the road segment.

13. The non-transitory computer-readable storage medium of claim 12, wherein the one or more instructions which, when executed by the one or more processors, further cause the device to:
receive the additional sensor data corresponding to the stationary object at the location along the road segment; and
based on the sensor data and the additional sensor data, modify the encoded level of uncertainty corresponding to the stationary object at the location along the road segment.

14. The non-transitory computer-readable storage medium of claim 8, wherein the one or more instructions which, when executed by the one or more processors, further cause the device to:
determine a level of priority corresponding to the encoded level of uncertainty; and
based on the determined level of priority, update the encoded level of uncertainty.

15. An apparatus, the apparatus comprising:
a processor; and
a memory comprising computer program code for one or more programs, wherein the computer program code is configured to cause the processor of the apparatus to:
receive uncertainty data associated with a stationary object at a location along a road segment;
generate a data point for a map layer associated with the road segment based on the uncertainty data, wherein the data point indicates a level of uncertainty associated with the stationary object at the location along the road segment; and
store the data point in a database associated with the map layer, wherein the map layer comprises the data point and one or more other data points that indicate one or more other locations corresponding to respective levels of uncertainty for one or more other stationary objects along one or more road segments.

16. The apparatus of claim 15, wherein the computer program code is configured to cause the processor of the apparatus to:
determine a level of priority corresponding to the stored data point; and
based on the determined level of priority, update the stored data point in the database.

17. The apparatus of claim 15, wherein the uncertainty data is based on sensor data corresponding to the stationary object captured via one or more sensors of at least one vehicle traveling along the road segment.

18. The apparatus of claim 15, wherein the computer program code is configured to cause the processor of the apparatus to:
receive additional sensor data corresponding to the stationary object; and
based on the additional sensor data, update the stored data point in the database.

19. The apparatus of claim 18, wherein the computer program code is configured to cause the processor of the apparatus to update the stored data point in the database further causes the processor of the apparatus to modify the level of uncertainty associated with the stationary object.

20. The apparatus of claim 19, wherein the computer program code is configured to cause the processor of the apparatus to modify the level of uncertainty associated with the stationary object further causes the processor of the apparatus to remove the stored data point in the database based on a decrease in the level of uncertainty.
